(19) United States
(12) Patent Application Publication
(10) Pub. No.: US 2011/0302841 A1
(43) Pub. Date: Dec. 15, 2011

(54) Swing gate operator

(75) Inventors: Bingmao Ye, Hangzhou (CN); Songyan Hu, Hangzhou (CN)

(73) Assignee: Hangzhou Sanford Tools Co., Ltd.

(21) Appl. No.: 12/802,830

(22) Filed: Jun. 14, 2010

(51) Int. Cl. E05F 15/04

(52) U.S. Cl. 49/340

(57) ABSTRACT

A swing gate operator for automatically and manually operating the gate opener for movably controlling the gate between an opened position and closed position, wherein the swing gate operator includes a gear motor being housed in a casing, a clutch device operatively coupling with an output end of the gear motor, and an operation arm having an outer sleeve outwardly extending from the casing. The operation arm includes at least one extendable shaft operatively coupling with the clutch device for slidably extending within the outer sleeve to operatively moving the gate between an opened position and a closed position.

### BACKGROUND OF THE PRESENT INVENTION

1. Field of Invention

The present invention relates to an automatic gate opener, and more particularly to a swing gate operator, which is able to be selectively operatively in a manual manner.

2. Description of Related Arts

A driveway gate or hallway gate is commonly used for fencing and separating the private area from the open area. In order to conveniently control the operation of the gate, an automatic or electrical gate opener is adapted to open and close the gate. Normally, the automatic gate opener is able to be wirelessly or wirely actuated via transmitting a corresponding signal to activate the motor to drive the door between the opened or closed position. Thus, a person in a car needs not to get off the car to manually operate the gate door.

Take the swing gate opener for example. One kind of the swing gate openers used a DC motor for driving a driven shaft of the gate opener, so that the driven shaft engaged with the gate is able to controllably drive the gate between the opened and closed position. The driven shaft is movably coupling with the motor via two or more gears. The mechanisms of this type of swing gate operation tend to be complicated and hard to do the maintenance, so that the manufacturing cost of this type of motor is costly. It is also making tremendous noise during the operation of the gate opener.

Another type of swing gate opener is using a worm shaft and worm gear to reduce the rotational speed of the motor, wherein the gate opener usually comprises a customized motor, driven shaft, and a leading screw, so that the motor is driving the worm shaft and worm gear to drive the driven shaft and the leading screw for automatically controlling the gate between the opened and closed position. In other words, the conventional swing gate may comprise the customized motor for incorporating with the gates according to its size, shape, and function thereof, a worm gear, a nut securing at the worm gear, and a worm gearing arrangement for decelerating the rotational speed of the worm gear. However, this type of motor for electrically operating the gate opener is complicated in structure, tremendously hard to maintain the device, and difficult to assemble the parts after dissembling the gate opener for maintenance purpose.

The above existing types of gate opener further have the drawbacks as followings. The driven shaft reciprocatively driven by the motor is limited via inner micro-switch when the shaft is moving toward the motor, and is limited via a photoelectric switch when the shaft is moving away from the motor. Thus, the driven shaft is substantially non-adjustable, so as to limit its applications and increase the complications of the structure of the gate opener.

The Hall limit switch is another commonly used limit method for limiting the opening and closing mechanism of the gate. However, the Hall limit determining the opening and closing position of the swing gate via measuring the rpm of the motor may render the inaccurate. Therefore, the existing swing gate openers are complicated in structure, inaccurate, and inconvenient for regulating or adjusting the limit switch of the openers.

Furthermore, most of the existing motor for the gate opener may not have the manual function, so that when the power is cut off, the motor loses its power to operate the gate opener. It is tremendously inconvenient if the gate is needed to be immediately opened for being passed through the driveway. In other words, the swing gate without the clutch apparatus incorporating with the mechanism of the gate opener is unable to be operated when the power is off. Therefore, when the supply power is cut, the swing gate is unable to be manually opened or closed for entering the gate. Thereby, an extra battery may have to electrically link to the gate opener mechanism as an emergency power source, which further increases the complication of the mechanism of the swing gate openers.

### SUMMARY OF THE PRESENT INVENTION

An objective of the present invention is to provide a swing gate operator, wherein a clutch device with simplified structure is adapted to incorporate with the motor of the gate opener, so as to minimize the volume of the swing gate operator.

Another objective of the present invention is to provide a gate opener, wherein a magnetic limit system is able to accurately limit the shifting movement of the extendable shaft and easily being regulated or adjusted.

Another objective of the present invention is to provide a gate opener, wherein the gate opener is able to selectively manually operate the gate opener via the locking member, so that when the power source is cut, the gate opener is able to be manually opened and closed.

Another objective of the present invention is to provide a gate opener, wherein the magnetic limit system is adapted for limiting the shifting movement of the extendable shaft, so as to determine and limit the opened position and the closed position of the gate.

Another objective of the present invention is to provide a gate opener, wherein a signal in responsive to the magnetic strength between the magnetic member shifting along the extendable shaft and the opening magnetic switch and between the magnetic member and the closing magnetic switch is able to be detected without directly contacting the extendable shaft and the magnetic limit system in an indirectly contacting manner, so as to enhance the sensibility of detecting the signal for accurately limiting the determined opened position and the closed position.

Another objective of the present invention is to provide a gate opener, wherein the overall structure of the swing gate operator is simplified so as to minimize the manufacturing cost thereof.

Accordingly, in order to accomplish the above objectives, the present invention provides a swing gate operator for automatically and manually operating the gate opener for movably controlling the gate between an opened position and closed position, wherein the swing gate operator comprises:
a gear motor being housed in a casing;
a clutch device operatively coupling with an output end of the gear motor;
an operation arm having an outer sleeve outwardly extending from the casing, wherein the operation arm comprises at least an extendable shaft operatively coupling with the clutch device by one end thereof via a thread drive arrangement for being driven to reciprocatively shift within the outer sleeve along an axis direction of the operation arm and coupling with a gate by an opposed end of the extendable shaft extending out of an opening of the outer sleeve for operatively moving the gate between an opened position and a closed position.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a swing gate operator according to a preferred embodiment of the present invention, illustrating the swing gate operator incorporating with a gate.

FIG. 2 is a side sectional view of the swing gate operator according to the preferred embodiment of the present invention.

FIG. 3 is a partial 3-dimentional view of the swing gate operator according to the preferred embodiment of the present invention.

FIG. 4A and 4B are a partial sectional view of a clutch element A and clutch element B of the swing gate operator according to the preferred embodiment of the present invention.

FIG. 5 is a 3-dimentional view of the clutch element A of the swing gate operator according to the preferred embodiment of the present invention.

FIG. 6 is a 3-dimentional view of the clutch element B of the swing gate operator according to the preferred embodiment of the present invention.

### DETAILED DESCRIPTION OF THE PREFERRED EMBODIMENT

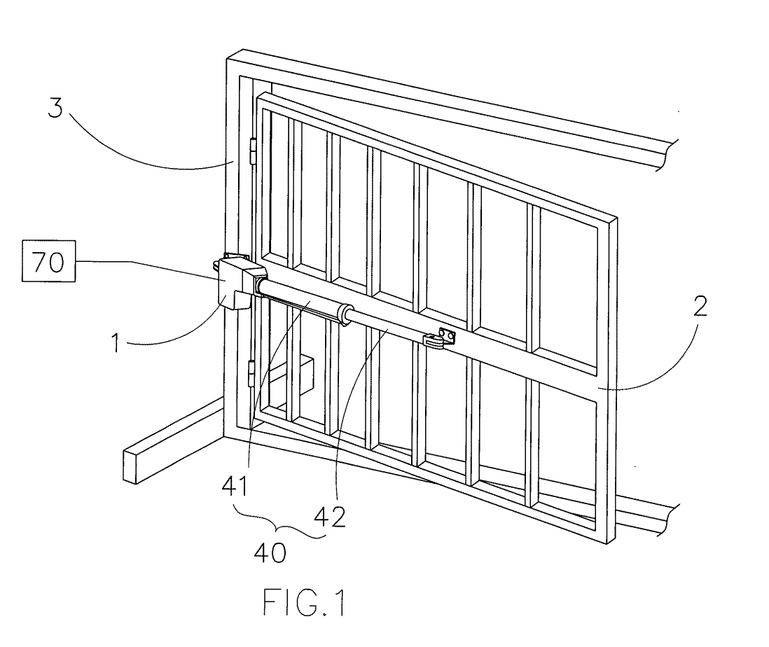

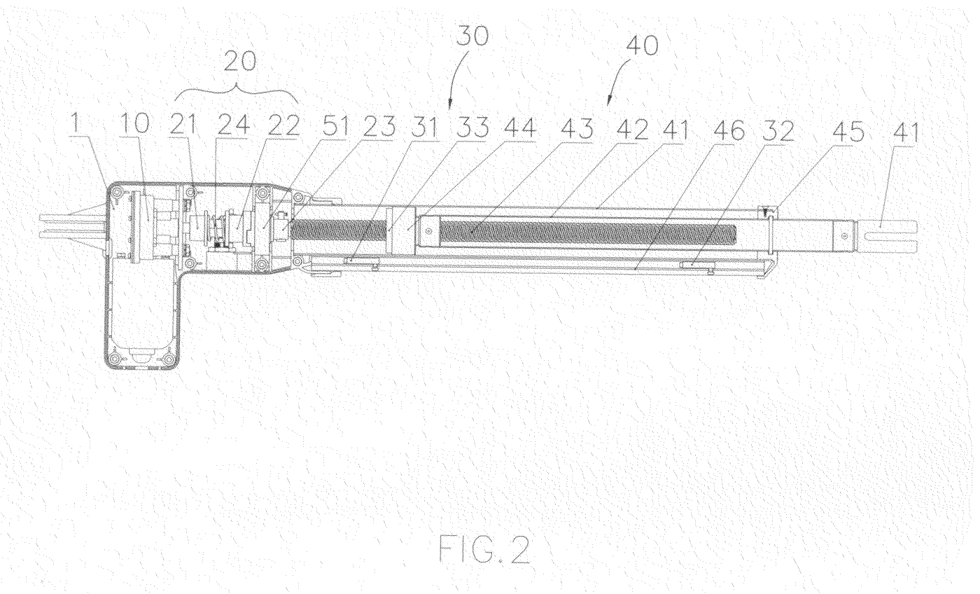

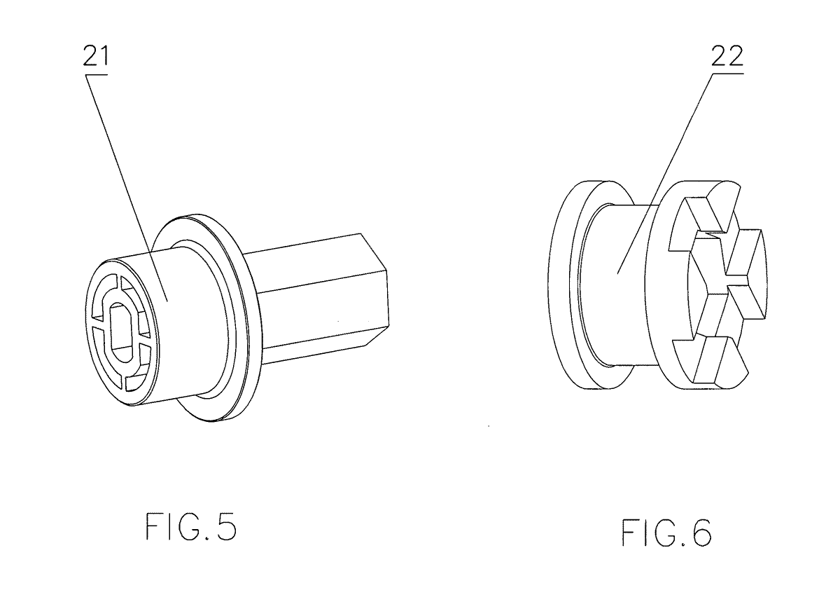

Referring to FIGS. 1 to 6 of the drawings, a swing gate operator according to a preferred embodiment of the present invention is illustrated, wherein the swing gate operator comprises a gear motor 10 being housed in a casing 1, a clutch device 20, a magnetic limit system 30, and an operation arm 40 operatively driving by the gear motor 10, wherein the operation arm 40 is extended from the casing 1 by one end to operatively connect with the gear motor 10 and coupled with a gate 2 by the other opposed end thereof via a connecting member 41 thereat. Thereby, the motor 10 is operatively connected with the operation arm 40 is able to drive the operation arm 40 extendably moving between an opened position for opening the gate 2 and a closed position for closing the gate 2. A bearing 51 is being supported and positioned at a supporting base in the casing 1 at a location coaxially aligning with an output end of the motor 10.

The clutch device 20 further comprises a first clutch member 21, a second clutch member 22, and a third clutch member 23, wherein the first clutch member 21 clutch device 20 is operatively connected to the output end of the motor 10 via the first clutch member 21. The first clutch member 21 is preferred to rotatably couple with the second clutch member 22, and the second clutch member 22 is preferably coupled with the third clutch member 23 through an Oldham coupler for transmitting a driving force from one to another. The third clutch member 23 may further be coaxially coupled with the bearing 51 for synchronously rotating in according to the rotational movement of the bearing 51.

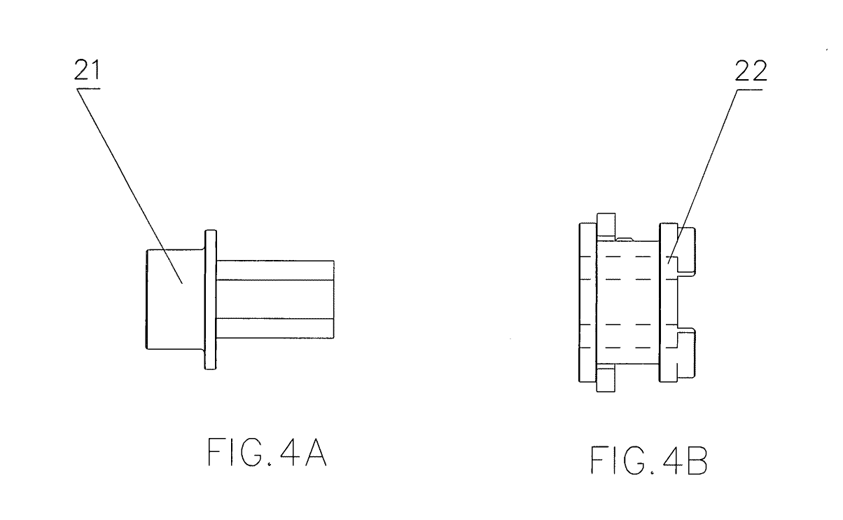

As best shown in FIGS. 4A, 4B, 5, and 6 of the drawings, each of the first and second clutch members 21, 22 preferably has a shape and size geometrically matching each other for interlocking therewith, so as to transfer the driving force between the first clutch member 21 and the second clutch member 22.

More specifically, the first clutch member 21 preferably has an outer hexagonal shaped portion while the second clutch member 22 preferably has an inner hexagonal shaped portion in according to the outer hexagonal shape of the first clutch member 21, so that the first clutch member 21 is able to be insertably received by the second clutch member 22 for coupling therewith. Thereby, the first clutch member 21 is able to interlockingly and slidably couple with the second clutch member 22. A spring element 24 is further provided at a position between the first clutch member 21 and the second clutch member 22, wherein the spring element 24 is preferably surrounding at an outer peripheral surface of the second clutch member 22, in such a manner that the second clutch member 22 only has a freedom of inwardly moving along an axis direction of the operation arm 40.

The swing gate operator further comprises an outer sleeve 41 and an extendable shaft 42, wherein the outer sleeve 41 is outwardly extending from the casing 1 at a position coaxially aligning with the motor 10 and the extendable shaft 42 is coaxially located within the outer sleeve 41 to slidably extending therewithin, so as to form the operation arm 40. A thread drive arrangement is further provided within the outer sleeve 41 of the operation arm 40. The thread drive arrangement comprises a guide screw 43 fixedly coupling with the third clutch member 23 by one end and a corresponding nut element 44 slidably and movably coupling with the screw element 43.

The extendable shaft 42 further has a linking member 41 fixed at a distal end of the extendable shaft 42 for connecting to the gate, wherein the opposed proximal end of the extendable shaft 42 is connected to one side of the nut member 44 for being slidably driven to coaxially slide within outer sleeve 41 therethrough, such that the gate is able to be driven to move between the opened position and the closed position thereof via the extendable shaft 42. A stopper 45 may further provided at an outer peripheral end of the outer sleeve 41 at a position for limiting the sliding movement along the axis of the operation arm 40 of the extendable shaft 42.

The gear motor 10 is preferably a worm gear motor, which has the benefit of low cost and is able to stability provide the driving force to the operation arm 40. The nut element 44 and the guide screw 43 are preferably trapezoid type nut element 44 and corresponding trapezoid type guide screw 43, which are able to efficiently and cooperatively driving the extendable shaft 42 to slidably extend within the outer sleeve 41.

Accordingly, the casing 1 is able to be mounted at a post 3 of the gate 2 or the like for operatively and electrically driving the gate to move between the opened position and the closed position. In other words, the motor 10 is being fixed within the casing 1, wherein the outer sleeve 41 preferably has a hollow cylindrical housing therein is outwardly extending from the casing 1 to coaxially align with the output end of the motor. The elongated guide screw 43 is rotatably being received within the outer sleeve 41 for coaxially coupling with the output end of the motor 10 through coupling with the third clutch member 23 of the clutch device 20. The nut element 44 is slidably coupling with the guide screw 43, so that when the motor 10 is driven the guide screw 43 to rotate, the nut element 44 is slidably and reciprocatively moving along the elongated guide screw 43 in the axis direction of the operation arm 40.

The extendable shaft 42 preferably has an elongated cylindrical shape movably and coaxially encircling the guide screw 43 at a position between the outer sleeve 41 and the guide screw 43, wherein the extendable shaft 42 is coupling with the nut element 44 by one end thereof for being coaxially positioned within the outer sleeve 41 and for being driven by the nut element 44 for slidably moving along the guide screw 43, such that the extendable shaft 42 is able to controllably extend and shorten a total length of the operation arm 40 via controlling the gear motor 10, so as to operatively moving the gate between the opened position and the closed position. At the opened position, the extendable shaft 42 is inwardly sliding toward the gear motor 10 for shortening the length of the operation arm 40; and the closed position, the extendable shaft 42 is outwardly sliding away from the output end of the motor 10.

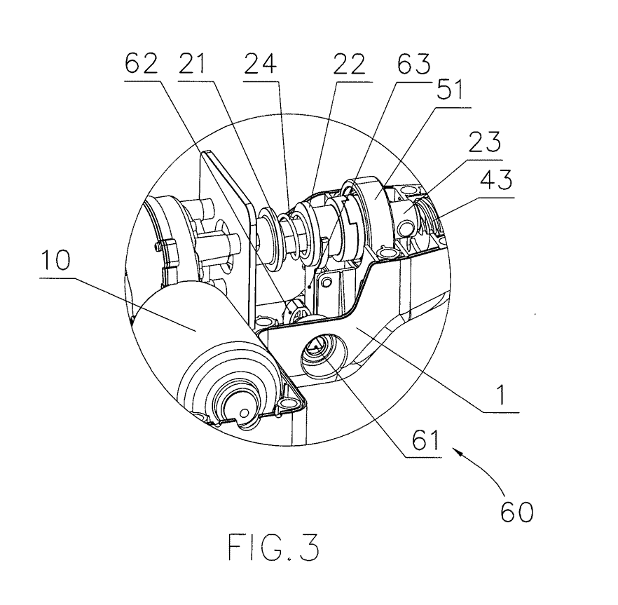

As best shown in FIG. 3 of the drawings, the swing gate operator may further comprises a manual switch arrangement 60, wherein the manual switch arrangement 60 preferably comprises a locking member 61, a cam 62, and a shift fork 63.

The cam 62, such as a wheel rotational cam or a cam plate, is employed for contact with the shift fork 63 for selectively disengaging the second clutch member 22 and the third clutch member 23 via the locking member 61, so that when the second and third clutch members 22, 23 are disengaged, the extendable shaft 42 is able to be manually operated for extendably sliding between the outer sleeve 41 and the guide screw 43 to move the gate between the opened position and the closed position.

More specifically, the locking member 61, preferably a triangular locker, is able to be rotatably driven via a corresponding locker key member to movably actuate the cam 62. The locking member 61 is preferably provided at an outer surrounding wall of the casing 1 at a position communicating with the cam 62 within the casing 1 in a hand reachable manner. When the cam 62 is actuated to push the shift fork 63, the second clutch member 22 is driven to inwardly move along the axis direction to compress the spring 24, so as to disconnect the Oldham coupler between the second and third clutch member 22, 23. Therefore, the transmission connection between the second clutch member 22 and the third clutch member 23 is disconnected for manually and reciprocatively sliding the extendable shaft 42 along the axis direction of the operation arm 40.

As will be readily appreciated by one skilled in the art, the selective manual operation of the swing gate operator is able to prevent the gate 2 being stuck between the opened position and the closed position during the loss of power or blackouts. In other words, during the power outage or any accidents, the corresponding locker key member is able to rotatably drive the locking member 61 to rotatably move the cam 62 for unlocking the engagement of the Oldham coupler of the second and third clutch members 22, 23, so as to switch to the manual operation mode of the swing gate operator. After the power is on, the locking member 61 is able to be driven to rotate in an opposed rotational direction via the locker key member, so that the spring 24 is able to push the second clutch member 22 to reengage with the third clutch member 23 for automatically and electrically driving the extendable shaft 42 slidably and reciprocatively moving along the axis direction of the operation arm 40.

In the preferred embodiment of the present invention, the magnetic limit system 30 further comprises an opening magnetic switch 31, a closing magnetic switch 32, and a magnetic member 33 preferably located on the nut element 44, so that when the extendable shaft 42 is movably sliding for driving the gate 2 moving between the opened position and closed position, the magnetic member 33, preferably a magnetic ring, is able to slidably and reciprocatively shift along nut element 44 in the axis direction.

The opening magnetic switch 31 and the closing magnetic switch 32 are spacedly located at an elongated sliding track 46, which is at the bottom of the outer sleeve 41 of the operation arm 40. In other words, the sliding track 46 is located within the hollow housing of the casing 1 and the stopper 45. The opening and closing magnetic switches 31, 32 are spacedly and slidably coupling with the sliding track 46, wherein the opening magnetic switch 31 is located adjacent to the proximal end of the extendable shaft 42 close to the motor 10, and the closing magnetic switch 32 is located adjacent to the distal end of the extendable shaft 42 near the linking member 421 thereat. Thereby, the opening magnetic switch 31 and the closing magnetic switch 32 are slidably moving along the sliding track 46.

Accordingly, a control circuit 70 is further electrically linking with the motor 10, wherein when the extendable shaft 42 is extendably being operated for opening and closing the gate 2 via the motor, the nut element 44 is driving the magnetic member 33 reciprocatively shifting along the guide screw 43, so as to generate a variety of magnetic force between the magnetic member 33 and the opening and closing magnetic switches 31, 32. Therefore, the changing of the magnetic filed of the magnetic limit system 30 generates a corresponding signal to motor 10 via the control circuit 70, so as to controllably limit the opening and closing operation of the swing gate operator for open or close the gate 2.

Take opening operation of the swing gate operator for example. During the opening operation, the nut element 44 carrying the magnetic member 33 is slidably and inwardly moving toward the opening magnetic switch 31 to generate a magnetic filed. In other words, when the magnetic member 33 is moving toward the motor 10 when and the opening magnetic switch 31 are close enough to generate an intensity of magnetic filed over a predetermined threshold, a “Stop” signal is transmitted to the gear motor 10 via the control circuit 70 to turn off the gear motor 10, so as to limit a shifting distance of the extendable shaft 42.

During the closing operation, the nut element 44 carrying the magnetic member 33 is slidably and inwardly moving toward the closing magnetic switch 32 to generate a magnetic filed. In other word, when the magnetic member 33 is moving away the motor 10 and toward the closing magnetic switch 32, which are close enough to generate an intensity of magnetic filed over a predetermined threshold, a “Stop signal is transmitted to the gear motor 10 via the control circuit 70 to turn off the gear motor 10, so as to limit a shifting movement of extendable shaft 42.

Therefore, the signal between the magnetic member 33 and the opening magnetic switch 31 and the signal between the magnetic member 33 and the closing magnetic switch 32 are detected during the opening operation and closing operation respectively in indirectly contacting manner. Thereby, the magnetic limit system 30 is able to sensitively detect the magnetic signals for enhancing the accuracy of limit the shifting movement of the extendable shaft 42.

The magnetic limit system 30 is able to conveniently be regulated or adjusted the limit of shifting movement of the operation arm 40 during the opening operation and closing operation of the swing gate operator simply via slidably adjusting the location of the opening magnetic switch 31 and closing magnetic switch 32 along the sliding track 46. Thus, the swing gate operator is able to universally install at variety of sizes and variety of purposes of the gates 2. For example, the swing gate operator is able to easily and accurately adjust the limit of shifting movement of the extendable shaft 42 for selectively adjusting the opened position and the closed position of the gate 2 in accordance to the different geometrical shape of the gate 2, locations, environments, or different applications of the gate 2.

The arrangement of the extendable shaft 42 being driven by the nut element 44 to reciprocatively move along the guide screw 43 in the axis direction of the operation arm 40 is able to minimize the overall volume of the swing gate operator, so as to reduce the required space for installing the swing gate operator and for enhancing the aesthetic feelings thereof. The clutch device 20 is able to be efficiently driven by the gear motor 10 for controllably operating the operation arm 40 via rotatably driving the guide screw 43 to extendably and reciprocatively move the extendable shaft 42 via the nut element 42.

To sum up, the transmission process from the gear motor 10 to the operation arm 40 is able to convert the rotational force from the output end of the gear motor 10, to the first clutch member 21, second clutch member 22, then third clutch member 23, and then to the guide screw 43, wherein through the nut element 44, the rotational force is converted into the shifting movement of the extendable shaft 42 for reciprocatively moving the extendable shaft 42 along the axis direction of the outer sleeve 41 of the operation arm 40. Therefore, the transmission process is able to efficiently transfer the work from the motor to the extendable shaft 42 for operatively driving the gate 2 moving between the opened position and the closed position. The structure of the clutch device 20 and the operation arm 40 are simplified, so as to minimize the manufacturing cost thereof. The indirectly contacting limit method of the magnetic limit system 30 is able to enhance the accuracy of limiting the shifting movement of the extendable shaft 42. The simplified structure and the easy adjusted magnetic limit system 30 require low maintains of the swing gate operator, so as to enhance the durability thereof.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A swing gate operator, comprising:
a gear motor being housed in a casing;
a clutch device operatively coupling with an output end of said gear motor;
an operation arm having an outer sleeve outwardly extending from said casing, wherein said operation arm comprises at least an extendable shaft operatively coupling with said clutch device by one end thereof via a thread drive arrangement for being driven to reciprocatively shift within said outer sleeve along an axis direction of said operation arm and coupling with a gate by an opposed end of said extendable shaft extending out of an opening of said outer sleeve for operatively moving said gate between an opened position and a closed position.

2. The swing gate operator, as recited in claim 1, wherein said thread drive arrangement comprising a guide screw having a plurality of outer threads and a nut element having corresponding inner threads for rotatably engaging with said outer threads, wherein said guide screw is coupling with said clutch device for being driven to reciprocatively rotate by one end and outwardly and elongatedly extending toward said opening of said outer sleeve, wherein said nut element is being driven by said guide screw to slidably and reciprocatively move along said guide screw in said axis direction, wherein said extendable shaft is coupling with said nut element for being driven to reciprocatively and extendably move along said axis direction for extendably controlling an opening operation of moving said gate at said opened position and a closing operation of moving said gate at said closed position.

3. The swing gate operator, as recited in claim 2, wherein said clutch device comprises a first clutch member operatively connecting to said output end of said gear motor, a second clutch member insertably interlocking with said first clutch member, and a third clutch member connected with said second clutch by one end and connected to said guide screw by the other end thereof for rotatably driving said guide screw to rotate.

4. The swing gate operator, as recited in claim 3, wherein said first clutch member has an outer hexagonal shaped portion and said second clutch member has an inner hexagonal shaped portion in according to said outer hexagonal shaped portion of said first clutch member for insertably receiving said first clutch member, so as to interlockingly connect said first and second clutch members.

5. The swing gate operator, as recited in claim 1, wherein a magnetic limit system is provided for limiting said opening and closing operation of said reciprocatively shifting movement of said extendable shaft for adjustably determining said opened position and said closed position of said gate in a magnetic detecting manner.

6. The swing gate operator, as recited in claim 3, wherein a magnetic limit system is provided for limiting said opening and closing operation of said reciprocatively shifting movement of said extendable shaft for adjustably determining said opened position and said closed position of said gate in a magnetic detecting manner.

7. The swing gate operator, as recited in claim 4, wherein a magnetic limit system is provided for limiting said opening and closing operation of said reciprocatively shifting movement of said extendable shaft for adjustably determining said opened position and said closed position of said gate in a magnetic detecting manner.

8. The swing gate operator, as recited in claim 5, wherein said magnetic limit system comprises a magnetic member at said nut element, an opening magnetic switch positioned at a sliding track elongatedly extending within said outer sleeve at a location adjacent to an inner end of said outer sleeve, and a closing magnetic switch positioned at said sliding track adjacent to an outer end of said outer sleeve, in such a manner that said magnetic member is reciprocatively sliding along said guide screw to generate a corresponding signal of a shifting location of said extendable shaft for limiting said shifting movement of said extendable shaft in responsive to a detected magnetic strengths between said magnetic member and said opening magnetic switch or closing magnetic switch.

9. The swing gate operator, as recited in claim 6, wherein said magnetic limit system comprises a magnetic member at said nut element, an opening magnetic switch positioned at a sliding track elongatedly extending within said outer sleeve at a location adjacent to an inner end of said outer sleeve, and a closing magnetic switch positioned at said sliding track adjacent to an outer end of said outer sleeve, in such a manner that said magnetic member is reciprocatively sliding along said guide screw to generate a corresponding signal of a shifting location of said extendable shaft for limiting said shifting movement of said extendable shaft in responsive to a detected magnetic strengths between said magnetic member and said opening magnetic switch or closing magnetic switch.

10. The swing gate operator, as recited in claim 7, wherein said magnetic limit system comprises a magnetic member at said nut element, an opening magnetic switch positioned at a sliding track elongatedly extending within said outer sleeve at a location adjacent to an inner end of said outer sleeve, and a closing magnetic switch positioned at said sliding track adjacent to an outer end of said outer sleeve, in such a manner that said magnetic member is reciprocatively sliding along said guide screw to generate a corresponding signal of a shifting location of said extendable shaft for limiting said shifting movement of said extendable shaft in responsive to a detected magnetic strengths between said magnetic member and said opening magnetic switch or closing magnetic switch.

11. The swing gate operator, as recited in claim 1, further comprising a manual switch arrangement for selectively manually operating said operation arm for controllably moving said gate between said opened and closed positions, wherein said manual switch arrangement comprises a locking member, a cam, and a shift fork operatively engaging with said third clutch member, wherein said cam is arranged to be driven by said locking member to actuate said shift fork for disengaging said second clutch member and said third clutch member, so as to manually operate said operation arm.

12. The swing gate operator, as recited in claim 8, further comprising a manual switch arrangement for selectively manually operating said operation arm for controllably moving said gate between said opened and closed positions, wherein said manual switch arrangement comprises a locking member, a cam, and a shift fork operatively engaging with said third clutch member, wherein said cam is arranged to be driven by said locking member to actuate said shift fork for disengaging said second clutch member and said third clutch member, so as to manually operate said operation arm.

13. The swing gate operator, as recited in claim 10, wherein said locking member is a triangular locker for being driven to movably actuate said cam, so as to actuate said shift fork for disengaging said second and third clutch members.

14. The swing gate operator, as recited in claim 1, wherein said gear motor is a worm gear motor.

15. The swing gate operator, as recited in claim 2, wherein said gear motor is a worm gear motor.

16. The swing gate operator, as recited in claim 13, wherein said gear motor is a worm gear motor.

17. The swing gate operator, as recited in claim 2, wherein said guide screw is a trapezoid shaped guide screw and said nut element is a trapezoid shaped nut element in accordance to said trapezoid guide screw.

18. The swing gate operator, as recited in claim 16, wherein said guide screw is a trapezoid shaped guide screw and said nut element is a trapezoid shaped nut element in accordance to said trapezoid guide screw.

19. The swing gate operator, as recited in claim 1, wherein a stopper is provided at an outer peripheral opening of said outer sleeve for restraining said shifting movement of said extendable shaft therethrough.

20. The swing gate operator, as recited in claim 18, wherein a stopper is provided at an outer peripheral opening of said outer sleeve for restraining said shifting movement of said extendable shaft therethrough.
